(19) United States
(12) Patent Application Publication
(10) Pub. No.: US 2012/0289437 A1
(43) Pub. Date: Nov. 15, 2012

(54) NON-AQUEOUS DRILLING ADDITIVE USEFUL TO PRODUCE A FLAT TEMPERATURE-RHEOLOGY PROFILE

(75) Inventors: DINO David, Cranbury, NJ (US); Yanhui CHEN, Plainsboro, NJ (US)

(73) Assignee: ELEMENTIS SPECIALTIES, INC., Hightstown, NJ (US)

(21) Appl. No.: 13/104,286

(22) Filed: May 10, 2011

(51) Int. Cl. C09K 8/035; C08G 69/26; C09K 8/24

(52) U.S. Cl. 507/117; 528/332

(57) ABSTRACT

The present application, at least in part, is directed to a method of providing a substantially constant rheological profile of an oil-based drilling fluid over a temperature range of about 120° F. to about 40° F. In some embodiments, the method comprises adding a drilling fluid additive to the drilling fluid, wherein the drilling fluid additive consists essentially of a polyamide and a set of at least one or more mono-carboxyl units. The polyamide has (a) repeat units of (i) a poly-carboxyl unit with at least two carboxylic moieties; and (ii) a polyamine unit having an amine functionality of two or more and the one or more mono-carboxyl units being positioned on the polyamide at a position selected from the group consisting of: an end position, a pendant position and combinations thereof.

### BACKGROUND OF THE INVENTION

Drilling fluids have been used since the very beginning of oil well drilling operations in the United States and drilling fluids and their chemistry are an important area for scientific and chemical investigations. Certain uses and desired properties of drilling fluids are reviewed in U.S. Patent Application 2004/0110642 and 2009/0227478 and U.S. Pat. Nos. 7,345,010, 6,339,048 and 6,462,096, issued to the assignee of this application, the entire disclosures of each are incorporated herein by reference.

Nevertheless, the demands of the oil-well drilling environment require increasing improvements in rheology control over broad temperature ranges. This becomes particularly true, for example, as the search for new sources of oil involves greater need to explore in deep water areas and to employ horizontal drilling techniques.

### SUMMARY OF THE INVENTION

The present disclosure provides for new additives that enable the preparation of drilling fluids with a substantially constant rheological profile over a wide range of temperatures. In certain embodiments, the new additives enable the preparation of oil-based drilling fluids with viscosities that are less affected by temperature over a temperature range from about 40° F. to more than about 120° F. compared to conventional drilling fluids. In addition, this invention permits the use of reduced amounts of organoclay rheological additives without loss of viscosity at low shear rates.

Accordingly, in one aspect, the present disclosure provides a composition consisting essentially of a polyamide having (a) repeat units of (i) a poly-carboxyl unit with at least two carboxylic moieties, and (ii) a polyamine unit having an amine functionality of two or more; and (b) one or more mono-carboxyl units, said mono-carboxyl units being positioned on the polyamide at a position selected from the group consisting of: an end position, a pendant position and combinations thereof.

According to another aspect, the present disclosure provides an oil-based drilling fluid, comprising a drilling fluid; and a drilling fluid additive consisting essentially of a polyamide having (a) repeat units of (i) a poly-carboxyl unit with at least two carboxylic moieties, and (ii) a polyamine unit having an amine functionality of two or more; and (b) one or more mono-carboxyl units, said mono-carboxyl units being positioned on the polyamide at a position selected from the group consisting of: an end position, a pendant position and combinations thereof.

In yet another aspect, the present disclosure provides a method of providing a substantially constant rheological profile of an oil-based drilling fluid over a temperature range of about 120° F. to about 40° F., comprising adding a drilling fluid additive to the drilling fluid, wherein the drilling fluid additive consists essentially of a polyamide having (a) repeat units of (i) a poly-carboxyl unit with at least two carboxylic moieties, and (ii) a polyamine unit having an amine functionality of two or more; and (b) one or more mono-carboxyl units, said mono-carboxyl units being positioned on the polyamide at a position selected from the group consisting of: an end position, a pendant position and combinations thereof.

In certain embodiments, the poly-carboxyl unit is derived from a dimer fatty acid. Suitable dimer fatty acids are selected from the group consisting of hydrogenated, partially hydrogenated and non-hydrogenated fatty dimer acids with from about 20 to about 48 carbon atoms.

In some embodiments, the polyamine unit is derived from a polyethylene polyamine.

In certain embodiments, the mono-carboxyl unit has a formula (R¹—C═O) wherein R¹ is a saturated or unsaturated hydrocarbon having from 3 carbon atoms to 22 carbon atoms. In an alternative embodiment, R¹ is an unsaturated hydrocarbon having from 3 carbon atoms to 22 carbon atoms and wherein R¹ is optionally substituted with one or more hydroxyl groups.

In further embodiments, the polyamine unit has an amine functionality of two or more and may include a linear or branched aliphatic or aromatic diamine having from 4 to 26 carbon atoms.

### DETAILED DESCRIPTION OF THE EMBODIMENTS

The present invention provides for methods to impart substantially constant equivalent circulating density (“ECD”) to an oil based drilling fluid over a temperature range of about 120° F. to about 40° F. by adding a drilling fluid additive to the oil based drilling fluid. In some embodiments, a drilling fluid additive includes a reaction product of (i) a poly-carboxylic acid having a carboxylic moiety of two or more, (ii) a polyamine having an amine functionality of two or more, and (iii) one or more carboxylic acids with a single carboxylic moiety (e.g., mono-carboxylic acids). In an alternative embodiment, the drilling fluid additive consists of a reaction product of (i) a poly-carboxylic acid having a carboxylic moiety of two or more, (ii) a polyamine having an amine functionality of two or more, and (iii) one or more carboxylic acids with a single carboxylic moiety (e.g., mono-carboxylic acids). In yet another embodiment, the drilling fluid additive consists essentially of a reaction product of (i) a poly-carboxylic acid having a carboxylic moiety of two or more, (ii) a polyamine having an amine functionality of two or more, and (iii) one or more carboxylic acids with a single carboxylic moiety (e.g., mono-carboxylic acids).

In some embodiments, a drilling fluid additive includes a reaction product of (i) a poly-carboxylic acid having a carboxylic moiety of two or more, and (ii) a polyamine having an amine functionality of two or more, and (iii) carboxylic acid with a single carboxylic moiety (e.g., a mono-carboxylic acid), wherein the poly-carboxylic acid is first reacted with the polyamine and the resulting product then reacted with the mono-carboxylic acid. In alternative embodiments, a drilling fluid additive consists of a reaction product of (i) a poly-carboxylic acid having a carboxylic moiety of two or more, and (ii) a polyamine having an amine functionality of two or more, and (iii) carboxylic acid with a single carboxylic moiety (e.g., a mono-carboxylic acid), wherein the poly-carboxylic acid is first reacted with the polyamine and the resulting product then reacted with the mono-carboxylic acid. In other alternative embodiments, a drilling fluid additive consists essentially of a reaction product of (i) a poly-carboxylic acid having a carboxylic moiety of two or more, and (ii) a polyamine having an amine functionality of two or more, and (iii) carboxylic acid with a single carboxylic moiety (e.g., a mono-carboxylic acid), wherein the poly-carboxylic acid is first reacted with the polyamine and the resulting product then reacted with the mono-carboxylic acid.

In yet other embodiments, the drilling fluid additive includes at least a polyamide having constituent units of: a poly-carboxylic acid unit with two carboxylic moieties, a polyamine unit having at least two primary amino groups and optionally at least one secondary amino group, and at least one mono-carboxyl unit, said mono-carboxyl units being positioned on the polyamide at a position selected from the group consisting of: an end position, a pendant position and combinations thereof. In alternative embodiments, the drilling fluid additive consists of at least a polyamide having constituent units of: a poly-carboxylic acid unit with two carboxylic moieties, a polyamine unit having at least two primary amino groups and optionally at least one secondary amino group, and at least one mono-carboxyl unit, said mono-carboxyl units being positioned on the polyamide at a position selected from the group consisting of: an end position, a pendant position and combinations thereof. In other alternative embodiments, the drilling fluid additive consists essentially of at least a polyamide having constituent units of: a poly-carboxylic acid unit with two carboxylic moieties, a polyamine unit having at least two primary amino groups and optionally at least one secondary amino group, and at least one mono-carboxyl unit, said mono-carboxyl units being positioned on the polyamide at a position selected from the group consisting of: an end position, a pendant position and combinations thereof.

In still yet other embodiments, the drilling fluid additive includes a polyamide (e.g., a polyamide) having constituent units of: a poly-carboxylic acid unit with two carboxylic moieties (e.g., a dicarboxylic acid), a polyamine unit having at least two primary amino groups and optionally at least one secondary amino group (e.g. diethylene triamine), and one or more mono-carboxyl units being positioned on the polyamide at a position selected from the group consisting of: an end position, a pendant position and combinations thereof and wherein the one or more mono-carboxyl units may be covalently bound to said position on the polyamide and/or form ammonium salt at the position. In alternative embodiments, the drilling fluid additive consists of a polyamide (e.g., a polyamide) having constituent units of: a poly-carboxylic acid unit with two carboxylic moieties (e.g., a dicarboxylic acid), a polyamine unit having at least two primary amino groups and optionally at least one secondary amino group (e.g. diethylene triamine), and one or more mono-carboxyl units being positioned on the polyamide at a position selected from the group consisting of: an end position, a pendant position and combinations thereof and wherein the one or more mono-carboxyl units may be covalently bound to said position on the polyamide and/or form ammonium salt at the position. In other alternative embodiments, the drilling fluid additive consists essentially of a polyamide (e.g., a polyamide) having constituent units of: a poly-carboxylic acid unit with two carboxylic moieties (e.g., a dicarboxylic acid), a polyamine unit having at least two primary amino groups and optionally at least one secondary amino group (e.g. diethylene triamine), and one or more mono-carboxyl units being positioned on the polyamide at a position selected from the group consisting of: an end position, a pendant position and combinations thereof and wherein the one or more mono-carboxyl units may be covalently bound to said position on the polyamide and/or form ammonium salt at the position.

Various dicarboxylic acids, mono-carboxylic acids and polyamines which may be used to produce various embodiments of reaction products or from which the constituent units are derived are described below. In embodiments of a drilling fluid additive consisting essentially of dicarboxylic acids, mono-carboxylic acids and polyamine, other reactants may be included that do not materially affect the basic and novel characteristic(s) of providing a substantially constant ECD to an oil based drilling fluid over a temperature range of about 120° F. to about 40° F.

Carboxylic Acids

According to some embodiments, the carboxylic acid reactant and/or carboxylic acid from which a mono- or a poly-carboxylic acid unit is derived (individually or collectively referred to herein as “carboxylic acid”) includes various carboxylic acids having one or more carboxylic moieties. In an embodiment, the poly-carboxylic acid unit is derived from a dimer fatty acid. In another embodiment, the dimer fatty acid is selected from the group consisting of hydrogenated, partially hydrogenated and non-hydrogenated fatty dimer acids with from about 20 to about 48 total carbon atoms. In yet another embodiment, the dimer fatty acid is selected from the group consisting of a C16 dimer fatty acid, a C18 dimer fatty acid and mixtures thereof. For the purposes of this application, the nomenclature C16 dimer fatty acid and C18 dimer fatty acid refers to the monocarboxylic acid used to form the dimer acid and the carbon number refers to the number of carbons of the monocarboxylic acid. Based on this definition, one of skill in the art will understand that the term “C16 dimer fatty acid” refers to a dimer acid having a total of 32 carbon atoms.

In an embodiment, the mono-carboxylic acid unit has a formula (R¹—C═O), wherein R¹ is a saturated or unsaturated hydrocarbon having from 3 carbon atoms to 22 carbon atoms. In one embodiment, R¹ is selected from a saturated or unsaturated hydrocarbon having from 3 carbon atoms to 6 carbon atoms, or from 3 carbon atoms to 10 carbon atoms, or from 6 carbon atoms to 10 carbon atoms, or from 6 to 22 carbon atoms, or from 10 to 22 carbon atoms. In an embodiment, the mono-carboxylic acid unit is derived from a carboxylic acid having 4 carbon atoms. In another embodiment, the mono-carboxylic acid unit is derived from a carboxylic acid having 6 carbon atoms. In yet another embodiment, the mono-carboxylic acid unit is derived from a carboxylic acid having 10 carbon atoms. In yet another embodiment, the mono-carboxylic acid unit is derived from a carboxylic acid having 10 carbon atoms.

In certain embodiments, the mono-carboxyl unit is derived from a set of one or more monocarboxylic acids selected from the group consisting of: butyric acid, hexanoic acid, octanoic acid, decanoic acid, dodecanoic acid, tetradecanoic acid, hexadecanoic acid, octadecanoic acid, eicosanoic acid, docosanoic acid, oleic acid, linoleic acid, and mixtures thereof.

In an alternative embodiment, the mono-carboxylic acid unit is derived from a set of one or more compounds of the formula R¹—COOH, wherein R¹ is a saturated or unsaturated hydrocarbon having from 3 carbon atoms to 22 carbon atoms and wherein R¹ is optionally substituted with one or more hydroxyl groups. In yet another embodiment, the mono-carboxylic acid is selected from the group consisting of 12-hydroxy-octadecanoic acid, and 12-hydroxy-9-cis-octadecenoic acid and mixtures thereof. In other embodiments, the carboxylic acid includes one or more of the following monocarboxylic acids: dodecanoic acid, octadecanoic acid, docosanoic acid, 12-hydroxy-octadecanoic acid, and 12-hydroxy-9-cis-octadecenoic acid and mixtures thereof. In one embodiment, the carboxylic acid is dodecanoic acid. In another embodiment, the carboxylic acid is docosanoic acid. In another embodiment, the carboxylic acid is 12-hydroxy-octadecanoic acid.

According to some embodiments, a mono-carboxylic acid reactant may include a mixture of two or more mono-carboxylic acids wherein the first mono-carboxylic acid includes one or more compounds of the formula R¹—COOH wherein R¹ is a saturated or unsaturated hydrocarbon having from 3 carbon atoms to 22 carbon atoms and the second mono-carboxylic acid includes one or more compounds of the formula R²—COOH wherein R² is a saturated or unsaturated hydrocarbon having from 3 carbon atoms to 22 carbon atoms. Exemplary mixtures of carboxylic acids include: oleic acid/decanoic acid; dodecanoic acid/hexanoic acid; 12-hydroxy-octadecanoic acid/hexanoic acid; and 12-hydroxy-octadecanoic acid/decanoic acid.

According to some embodiments, polycarboxylic acid reactant from which a polycarboxylic acid unit is derived includes various carboxylic acids having at least two carboxylic moieties. Any carboxylic acid with at least two carboxylic moieties can be used for producing the reaction product component of the present invention. Dimer acids are preferred. Generally when used, the dimer acids preferably have an average from about 18, preferably from about 28 to about 48 and more preferably to about 40 carbon atoms. Most preferably dimer acids have 36 carbon atoms. Useful dimer acids are preferably prepared from C18 fatty acids, such as oleic acids. Useful dimer acids are described in U.S. Pat. Nos. 2,482,760, 2,482,761, 2,731,481, 2,793,219, 2,964,545, 2,978,468, 3,157,681, and 3,256,304, the entire disclosures of each are incorporated herein by reference. Such dimer acids can be fully hydrogenated, partially hydrogenated, or not hydrogenated at all.

Examples of most preferred dimer acids include the Empol® product line available from Cognis, Inc., Pripol™ dimer acids available from Uniqema and HYSTRENE® dimer acids formerly available from Humko Chemical.

It is recognized that commercially available dimer fatty acids contain a mixture of monomer, dimer, and trimer acids. Preferably, in order to achieve optimal results, the dimer fatty acid used has a specific dimer acid content as increased monomer and trimer concentration hinder the additive's performance. A person of ordinary skills in the art recognizes that commercial products may be distilled or otherwise processed to ensure certain dimer content. Preferably, suitable dimer acid has a dimer content of at least 80%, more preferably above 90%.

Polyamines

According to some embodiments, the polyamine reactant and/or polyamine from which a polyamine unit is derived (individually or collectively referred to herein as “polyamine”) includes a polyamine having an amine functionality of two or more. In one embodiment, the polyamine unit is derived from a polyethylene polyamine. In another embodiment, the polyamine is selected from the group consisting of ethylenediamine, diethylenetriamine, triethylenetriamine and tetrayethylenepentamine. In yet another embodiment, the polyamine is diethylenetriamine.

Generally when used, the polyamine includes a linear or branched aliphatic or aromatic polyamine having from 2 to 36 carbon atoms. Di-, tri-, and polyamines and their combinations may be suitable. Examples of such amines includes one or more of the following di- or triamines:tetramethylenediamine, pentamethylenediamine, hexamethylenediamine, dimer diamines and mixtures thereof. In yet another embodiment, the polyamine includes one or more of the following: ethylenediamine, hexamethylenediamine, diethylenetriamine and mixtures thereof. In another embodiment, the polyamine includes a polyethylene polyamine of one or more of the following: ethylenediamine, hexamethylenediamine, diethylenetriamine and mixtures thereof.

In some embodiments, di-, tri-, and polyamines and their combinations are suitable for use in this invention. In such embodiments, polyamines include ethylenediamine, diethylenetriamine, triethylenetetramine, tetraethylenepentamine and other members of this series. In one such embodiment, a suitable triamine is diethylenetramine (DETA). DETA has been assigned a CAS No. of 111-40-0 and is commercially available from Huntsman International.

In other embodiments, a suitable polyamine includes aliphatic dimer diamine, cycloaliphatic dimer diamine, aromatic dimer diamine and mixtures thereof and Priamine® 1074 from Croda Coatings and Polymers.

Preparation of the Polyamide Reaction Product

A polyamide according to the present invention may be prepared by various methods, including procedures A and B described below.

Procedure A: a Two-Step Process:

A polyamide according to the present invention may be prepared by a two-step process. In a first step, a poly-carboxylic acid (e.g., a di-carboxylic acid) and a polyamine (e.g., diethylene triamine) are combined at a mole ratio of carboxylic acid groups: amine groups ranging from: 1:1 to 1:3 or 1:1 to 1:2, either in the presence or absence of an acid (e.g., phosphoric acid) or before the acid added. The resulting mixture is then heated at about 200° C. for about 6 hours or until the acid number is less than 2 to 5 and the amine value is less than 160 to 200. Acid and amine values are used to determine when the reaction has completed to form a first polyamide product. The reaction product is cooled to 135° C. and then discharged onto a cooling tray to facilitate isolation of the crude first polyamide product and/or purification thereof and further cool. In a second step, the first polyamide product is then combined with a set of one or more mono-carboxylic acids (ranging in amounts from about 15 wt % to 100 wt % of the crude or purified polyamide product) and then heated 70 to 80° C. for at least 1 hour to form the desired polyamide product. The consumption of free acid can be determined by IR analysis to monitor reaction completion.

Procedure B: a One-Step Process

A polyamide according to the present invention may be prepared by a one-step process. A polyamine (e.g., diethylene triamine); a poly-carboxylic acid (e.g., a di-carboxylic acid) and one or more monocarboxylic acids are combined either in the presence or absence of an acid (e.g., phosphoric acid) or before the acid added. The polyamine, poly-carboxylic acid and mono-carboxylic acid are combined at a mole ratio of carboxylic acid groups: amine groups ranging from: 1:0.5 to 1:3; 1:1 to 1:3; or 1:1 to 1:2. To form the desired polyamide product, the resulting mixture is then heated to about 200° C. for about 6 hours or until the acid number is less than 2 to 5 and the amine value is less than 160 to 200. Acid and amine values are used to determine the reaction has completed.

Exemplary Drilling Fluid Additive Compositions

In one embodiment, the polyamide drilling fluid additive includes a composition based on a polyethylene polyamine. In one such embodiment, the polyamide drilling fluid includes a composition having constituent units derived from: dimer acids of C₁₆ and C₁₈ fatty acid and diethylene triamine and one or more mono-carboxylic acids having the formula R¹—COOH, wherein R¹ is a saturated or unsaturated hydrocarbon having from 3 carbon atoms to 22 carbon atoms. In another such embodiment, the polyamide drilling fluid additive includes a composition having constituent units derived from: dimer acid of C₁₆ and C₁₈ fatty acid, diethylene triamine and oleic acid. In another such embodiment, the polyamide drilling fluid additive includes a composition having of constituent units derived from: Empol® product line available from Cognis Inc. diethylene triamine and oleic acid. In yet another such embodiment, the polyamide drilling fluid additive includes a composition having of constituent units derived from: Pripol® dimer acids available from Uniqema and diethylene triamine.

Making the Drilling Fluid Additive

Specifics on processing of polyamines and carboxylic acids are well known and can be used in making the reaction product for incorporation in the drilling fluid additive. In some embodiments, the molar ratio between the amine functional group and carboxyl functional group is about 4:1 to about 1:0.5. In some embodiments, the molar ratio between the amine functional group and carboxyl functional group is about 3:1 to about 1:1. In some embodiments, the molar ratio between the amine functional group and carboxyl functional group is: about 3:1; about 2:1; and about 1:1. In some embodiments, the molar ratio between the amine functional group and carboxyl functional group is about 1:1. In some embodiments, mixtures of more than one carboxylic acid and/or more than one polyamine can be used.

Preparation of the Drilling Fluids

In some embodiments, compositions according to the present invention may be used as an additive to oil- or synthetic-based drilling fluids. In some embodiments, compositions according to the present invention may be used as an additive for oil- or synthetic-based invert emulsion drilling fluids employed in a variety of drilling applications.

The term oil- or synthetic-based drilling fluid is defined as a drilling fluid in which the continuous phase is hydrocarbon based. Oil- or synthetic-based drilling fluids formulated with over 5% water or brine may be classified as oil- or synthetic-based invert emulsion drilling fluids. In some embodiments, oil- or synthetic-based invert emulsion drilling fluids may contain water or brine as the discontinuous phase in any proportion up to about 50%. Oil muds may include invert emulsion drilling fluids as well as all oil based drilling fluids using synthetic, refined or natural hydrocarbon base as the external phase.

According to some embodiments, a process for preparing invert emulsion drilling fluids (oil muds) involves using a mixing device to incorporate the individual components making up that fluid. In some embodiments, primary and secondary emulsifiers and/or wetting agents (surfactant mix) are added to the base oil (continuous phase) under moderate agitation. The water phase, typically a brine, may be added to the base oil/surfactant mix along with alkalinity control agents and acid gas scavengers. In some embodiments, rheological additives as well as fluid loss control materials, weighting agents and corrosion inhibition chemicals may also be included. The agitation may then be continued to ensure dispersion of each ingredient and homogenize the resulting fluidized mixture.

Base Oil/Continuous Phase

According to some embodiments, diesel oil, mineral oil, synthetic oil, vegetable oil, fish oil, paraffin, and/or ester-based oils can all be used as single components or as blends.

Brine Content

In some embodiments, water in the form of brine is often used in forming the internal phase of the drilling fluids. According to some embodiments, water can be defined as an aqueous solution which can contain from about 10 to 350,000 parts-per-million of metal salts such as lithium, sodium, potassium, magnesium, cesium, or calcium salts. In some embodiments, brines used to form the internal phase of a drilling fluid according to the present invention can also contain about 5% to about 35% by weight calcium chloride and may contain various amounts of other dissolved salts such as sodium bicarbonate, sodium sulfate, sodium acetate, sodium borate, potassium chloride, sodium chloride or formate (such as sodium, calcium, or cesium). In some embodiments, glycols or glycerin can be used in place of or in addition to brines.

In some embodiments, the ratio of water (brine) to oil in the emulsions according to the present invention may provide as high of brine content as possible while still maintaining a stable emulsion. In some embodiments, suitable oil/brine ratios may be in the range of about 97:3 to about 50:50. In some embodiments, suitable oil/brine ratios may be in the range of about 90:10 to about 60:40, or about 80:20 to about 70:30. In some embodiments, the preferred oil/brine ratio may depend upon the particular oil and mud weight. According to some embodiments, the water content of a drilling fluid prepared according to the teachings of the invention may have an aqueous (water) content of about 0 to 50 volume percent.

Organoclays/Rheological Additives Other than Organoclays

In some embodiments, the drilling fluid additive includes an organoclay. According to some embodiments, organoclays made from at least one of bentonite, hectorite and attapulgite clays are added to the drilling fluid additive. In one embodiment, the organoclay is based on bentonite, hectorite or attapulgite exchanged with a quaternary ammonium salt having the following formula:

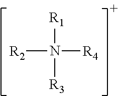

where R₁, R₂, R₃ or R₄ are selected from (a) benzyl or methyl groups; (b) linear or branched long chain alkyl radicals having 10 to 22 carbon atoms; (c) aralkyl groups such as benzyl and substituted benzyl moieties including fused ring moieties having linear or branched 1 to 22 carbon atoms in the alkyl portion of the structure; (d) aryl groups such as phenyl and substituted phenyl including fused ring aromatic substituents; (e) beta, gamma unsaturated groups; and (f) hydrogen.

In another embodiment, the organoclay is based on bentonite, hectorite or attapulgite exchanged with a quaternary ammonium ion including dimethyl bis[hydrogenated tallow] ammonium chloride (“2M2HT”), benzyl dimethyl hydrogenated tallow ammonium chloride (“B2 MHT”), trimethyl hydrogenated tallow ammonium chloride (“3 MHT”) and methyl benzyl bis[hydrogenated tallow] ammonium chloride (“MB2HT”).

There are a large number of suppliers of such clays in addition to Elementis Specialties' BENTONE® product line including Rockwood Specialties, Inc. and Sud Chemie GmbH. In addition to or in place of organoclays, polymeric rheological additives, such as THIXATROL® DW can be added to the drilling fluid. Examples of suitable polymeric rheological additives are described in U.S. Patent Application Publication No. 2004/0110642, which is incorporated by reference herein in its entirety.

Emulsifiers

According to some embodiments, an emulsifier can also be added to the drilling fluid in order to form a more stable emulsion. The emulsifier may include organic acids, including but not limited to the monocarboxyl alkanoic, alkenoic, or alkynoic fatty acids containing from 3 to 20 carbon atoms, and mixtures thereof. Examples of this group of acids include stearic, oleic, caproic, capric and butyric acids. In some embodiments, adipic acid, a member of the aliphatic dicarboxylic acids, can also be used. According to some embodiments, suitable surfactants or emulsifiers include fatty acid calcium salts and lecithin. In other embodiments, suitable surfactants or emulsifiers include oxidized tall oil, polyaminated fatty acids, and partial amides of fatty acids.

In some embodiments, heterocyclic additives such as imidazoline compounds may be used as emulsifiers and/or wetting agents in the drilling muds. In other embodiments, alkylpyridines may be used to as emulsifiers and/or wetting agents in the drilling muds.

Industrially obtainable amine compounds for use as emulsifiers may be derived from the epoxidation of olefinically unsaturated hydrocarbon compounds with subsequent introduction of the N function by addition to the epoxide group. The reaction of the epoxidized intermediate components with primary or secondary amines to form the corresponding alkanolamines may be of significance in this regard. In some embodiments, polyamines, particularly lower polyamines of the corresponding alkylenediamine type, are also suitable for opening of the epoxide ring.

Another class of the oleophilic amine compounds that may be suitable as emulsifiers are aminoamides derived from preferably long-chain carboxylic acids and polyfunctional, particularly lower, amines of the above-mentioned type. In some embodiments, at least one of the amino functions is not bound in amide form, but remains intact as a potentially salt-forming basic amino group. The basic amino groups, where they are formed as secondary or tertiary amino groups, may contain hydroxyalkyl substituents and, in particular, lower hydroxyalkyl substituents containing up to five and in some embodiments up to three carbon atoms in addition to the oleophilic part of the molecule.

According to some embodiments, suitable N-basic starting components for the preparation of such adducts containing long-chain oleophilic molecule constituents may include but are not limited to monoethanolamine or diethanolamine.

Weighting Agents

In some embodiments, weighting materials are also used to weight the drilling fluid additive to a desired density. In some embodiments, the drilling fluid is weighted to a density of about 8 to about 18 pounds per gallon and greater. Suitable weighting materials may include barite, ilmenite, calcium carbonate, iron oxide and lead sulfide. In some embodiments, commercially available barite is used as a weighting material.

Filtrate Reducers

In some embodiments, fluid loss control materials are added to the drilling fluid to control the seepage of drilling fluid into the formation. In some embodiments, fluid loss control materials are lignite-based or asphalt-based. Suitable filtrate reducers may include amine treated lignite, gilsonite and/or elastomers such as styrene butadiene.

Blending Process

In some embodiments, drilling fluids may contain about 0.1 pounds to about 15 pounds of the drilling fluid additive per barrel of fluids. In other embodiments, drilling fluids may contain about 0.1 pounds to about 10 pounds of the drilling fluid additive per barrel of fluids, and in still other embodiments, drilling fluids may contain about 0.1 pounds to about 5 pounds of the drilling fluid additive per-barrel of fluids.

As shown above, a skilled artisan will readily recognize that additional additives such as weighting agents, emulsifiers, wetting agents, viscosifiers, fluid loss control agents, and other agents can be used with a composition according to the present invention. A number of other additives besides rheological additives regulating viscosity and anti-settling properties can also be used in the drilling fluid so as to obtain desired application properties, such as, for example, anti-settling agents and fluid loss-prevention additives.

In some embodiments, the drilling fluid additive can be cut or diluted with solvent to vary the pour point or product viscosity. Any suitable solvent or combination of solvents may be used. Suitable solvents may include but are not limited to: diesel, mineral or synthetic oils, block copolymers of EO/PO and/or styrene/isoprene, glycols including polyalkylene glycols, alcohols including polyethoxylated alcohols, polyethoxylated alkyl phenols or polyethoxylated fatty acids, various ethers, ketones, amines, amides, terpenes and esters.

Method of Use

In some embodiments, a drilling fluid additive may be added to a drilling fluid. In some embodiments, the drilling fluid additive may be added to a drilling fluid in combination with other additives, such as organoclays discussed above.

In some embodiments, a drilling fluid additive is added to a drilling fluid in an amount of about 0.1 ppb to about 30 ppb. In other embodiments, a drilling fluid additive is added to a drilling fluid in an amount of about 0.1 ppb to about 15.0 ppb. In other embodiments, a drilling fluid additive is added to a drilling fluid in an amount of about 0.25 ppb to about 15.0 ppb. In other embodiments, a drilling fluid additive is added to a drilling fluid in an amount of about 0.1 ppb to about 5 ppb. In other embodiments, a drilling fluid additive is added to a drilling fluid in an amount of about 0.25 ppb to about 5 ppb. In some embodiments, a drilling fluid additive is added to a drilling fluid in an amount of about 0.5 ppb. In some embodiments, a drilling fluid additive is added to a drilling fluid in an amount of about 0.75 ppb. In some embodiments, a drilling fluid additive is added to a drilling fluid in an amount of about 1.0 ppb. In some embodiments, a drilling fluid additive is added to a drilling fluid in an amount of about 1.5 ppb. In some embodiments, a drilling fluid additive is added to a drilling fluid in an amount of about 2.0 ppb. In some embodiments, a drilling fluid additive is added to a drilling fluid in an amount of about 5.0 ppb. In some embodiments, a smaller amount of a drilling fluid additive of the present invention is required to achieve comparable rheological stability results as a known drilling fluid additive.

The drilling fluid additive and drilling fluid may be characterized by several rheological or hydraulic aspects, i.e., ECD, high shear rate viscosity, low shear rate viscosity, plastic viscosity, regulating property viscosity and yield point, of a drilling fluid. The rheological aspects may be determined using a Farm viscometer as per standard procedures found in API RP13B-2 “Standard Procedures for Field Testing Oil-based Drilling Fluids”. Viscosity readings can be measured at 600 rpm, 300 rpm, 200 rpm, 100 rpm, 6 rpm and 3 rpm. ECD can be determined by: standard hydraulics calculations found in API RP13D “Rheology and Hydraulics of Oil-well Drilling Fluids.” For the purposes of this invention high shear rate viscosity (“HSR”) corresponds to the viscosity measured at 600 rpm as per API RP13B-2 procedures. For the purposes of this invention, low shear rate viscosity (“LSR”) corresponds to the viscosity measured at 6 rpm as per API RP 13B-2 procedures. Plastic viscosity (“PV”) corresponds to the 600 rpm reading minus the 300 rpm reading. Yield Point (“YP”) corresponds to the 300 rpm reading minus plastic viscosity.

In some embodiments, the addition of the drilling fluid additive to an oil based drilling fluid results in a substantially constant ECD as temperature is varied over a range of about 120° F. to about 40° F. Any additional ingredient which materially changes the novel characteristic of the oil based drilling fluid, of a substantially constant ECD, is excluded from the drilling fluid additive or oil-based drilling fluid. For the purposes of this invention, a substantially constant ECD may include a decrease or increase in ECD over such temperature variation. In one embodiment, the increase in ECD may include: up to 0.5%; up to 1%; up to 2%, up to 3%, up to 4%; up to 5%; up to 10%; up to 20%; up to 30%; and up to 40%. In one embodiment, the decrease in ECD may include: up to 0.5%; up to 1%; up to 2%, up to 3%, up to 4%; up to 5%; up to 10%; up to 20%; up to 30%; and up to 40%. In one embodiment, the increase in ECD may range from 1% up to 10%. In another embodiment, the increase in ECD may range from 1% up to 5%.

In some embodiments, a drilling fluid according to the present invention may have a lower viscosity at 40° F. than conventional muds formulated with sufficient organoclay to provide suspension at bottom hole temperatures. When used in drilling operations, drilling fluids according to the present invention may allow the use of a lower pumping power to pump drilling muds through long distances, thereby reducing down-hole pressures. Consequently, in some embodiments, whole mud loss, fracturing and damage of the formation are all minimized. In some embodiments, drilling fluids according to the present invention may maintain the suspension characteristics typical of higher levels of organoclays at higher temperatures. Such suspension characteristics may reduce the tendency of the mud to sag. Sag may include the migration of weight material, resulting in a higher density mud at a lower fluid fraction and a lower density mud at a higher fluid fraction. A reduction of sag may be valuable in both deep water drilling as well as conventional (non deep water) drilling. The present invention may be particularly useful in deep water drilling when the mud is cooled in the riser. A mud using a drilling fluid additive according to the present invention will maintain a reduced viscosity increase in the riser when compared to drilling fluids containing conventional rheological additives.

Blending Process

Drilling fluids preparations preferably contain between ¼ and 15 pounds of the inventive mixture per barrel of fluids, more preferred concentration is ¼ to 10 pounds-per-barrel and most preferably ¼ to 5 pounds-per-barrel.

As shown above, a skilled artisan will readily recognize that additional additives: weighting agents, emulsifiers, wetting agents, viscosifiers, fluid loss control agents, and other agents can be used with this invention. A number of other additives besides rheological additives regulating viscosity and anti-settling properties, providing other properties, can also be used in the fluid so as to obtain desired application properties, such as, for example, anti-settling agents and fluid loss-prevention additives.

For the purposes of this application, the term “about” means plus or minus 10%.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

### Example 1

### Preparation of a Drilling Additive by a Two-Step Process

### Step 1: Preparation of IM-1

To a 500 ml reaction kettle equipped with a nitrogen inlet, stirrer, Dean Stark trap and a condenser, a C₁₆-C₁₈ dimer acid was charged and heated until a molten solid was obtained while stirring at 350 rpm. Diethylenetriamine was added, at a mole ratio of carboxylic acid groups: amine groups ranging from 1:1 to 1:3, and mixed for 5 minutes. The reaction was heated at 200° C. for 6 hours or until the acid number was less than 5 and the amine value was less than 200. The reaction mixture was cooled to 135° C. and then discharged onto a cooling tray to facilitate isolation of a crude polyamide product and/or purification thereof and further cooling. The polyamide product was labeled IM-1.

### Step 2: Reaction of IM-1 with a Mono-Carboxylic Acid

IM-1 was combined with at least one mono-carboxylic acid ranging in amount from about 15 wt % to 100 wt % of IM-1. The resulting mixture was heated at 80° C. for 1 hour or until the acid was consumed as analytically determined by IR

### Example 1a

### Reaction Product of IM-1 with 15 wt % Oleic Acid

Using the procedure of step 2 of Example 1 the titled compound was prepared by reacting IM-1 with 15 wt % Oleic Acid.

### Example 1b

### Reaction Product of IM-1 with 25 wt % Oleic Acid

Using the procedure of step 2 of Example 1 the titled compound was prepared by reacting IM-1 with 25 wt % Oleic Acid.

### Example 1c

### Reaction Product of IM-1 with 50 wt % Oleic Acid

Using the procedure of step 2 of Example 1 the titled compound was prepared by reacting IM-1 with 50 wt % Oleic Acid.

### Example 1d

### Reaction Product of IM-1 with 100 wt % Oleic Acid

Using the procedure of step 2 of Example 1 the titled compound was prepared by reacting IM-1 with 100 wt % Oleic Acid.

### Example 2

### Preparation Of A Drilling Additive By A One-Step Process

To a 500 ml reaction kettle equipped with a nitrogen inlet, stirrer, Dean Stark trap and a condenser, a C₁₆-C₁₈ dimer acid and diethylenetriamine at a mole ratio of carboxylic acid groups: amine groups ranging from 1:1 to 1:3, a set of at least one mono-carboxylic acid ranging in amount from about 15 wt % to 100 wt % were combined and heated at 200° C. for 6 hours or until the acid number was less than 5 and the amine value was less than 200. The reaction mixture was cooled to 135° C. and then discharged onto a cooling tray to facilitate isolation of a crude polyamide product and/or purification thereof and promote further cooling.

### Example 2a

### Reaction Product of Diethylenetriamine with C₁₆-C₁₈ Dimer Acid with 15 wt % Oleic Acid

Using the procedure of Example 2 the titled compound was prepared by reacting Diethylenetriamine with C₁₆-C₁₈ Dimer Acid and 15 wt % Oleic Acid.

### Example 2b

### Reaction Product of Diethylenetriamine with C₁₆-C₁₈ Dimer Acid and 25 wt % Oleic Acid

Using the procedure of Example 2 the titled compound was prepared by reacting Diethylenetriamine with C₁₆-C₁₈ Dimer Acid and 25 wt % Oleic Acid.

### Example 2c

### Reaction Product of Diethylenetriamine with C₁₆-C₁₈ Dimer Acid and 50 wt % Oleic Acid

Using the procedure of Example 2 the titled compound was prepared by reacting Diethylenetriamine with C₁₆-C₁₈ Dimer Acid and 50 wt % Oleic Acid.

### Example 2d

### Reaction Product of Diethylenetriamine with C₁₆-C₁₈ Dimer Acid and 100 wt % Oleic Acid

Using the procedure of Example 2 the titled compound was prepared by reacting Diethylenetriamine with C₁₆-C₁₈ Dimer Acid and 100 wt % Oleic Acid.

### Example 2e

### Reaction Product of Diethylenetriamine (139.4 moles) With C₁₆-C₁₈ Dimer Acid; Oleic Acid (8.17 moles); and Decanoic Acid (205.29 moles)

Using the procedure of Example 2 the titled compound was prepared by reacting Diethylenetriamine (139.4 moles) with C₁₆-C₁₈ Dimer Acid, Oleic Acid (8.17 moles), and Decanoic Acid (205.29 moles).

### Example 2f

### Reaction Product of Diethylenetriamine (139.4 moles) with C₁₆-C₁₈ Dimer Acid; Oleic Acid (8.17 moles); and Butyric Acid (401.35 moles)

Using the procedure of Example 2 the titled compound was prepared by reacting Diethylenetriamine (139.4 moles) with C₁₆-C₁₈ Dimer Acid, Oleic Acid (8.17 moles), and Butyric Acid (401.35 moles).

### Example 2g

### Reaction Product of Diethylenetriamine (139.4 moles) with Cₘ—Cᵢₛ Dimer Acid; Oleic Acid (8.17 moles); and Behenic Acid (103.83 moles)

Using the procedure of Example 2 the titled compound was prepared by reacting Diethylenetriamine (139.4 moles) with C₁₆-C₁₈ Dimer Acid, Oleic Acid (8.17 moles), and Behenic Acid (103.83 moles).

### Example 2h

### Reaction Product of Diethylenetriamine (139.4 moles) with C₁₆-C₁₈ Dimer Acid; Oleic Acid (8.17 moles); and Behenic Acid (103.83 moles)

Using the procedure of Example 2 the titled compound was prepared by reacting Diethylenetriamine (139.4 moles) with C₁₆-C₁₈ Dimer Acid, Oleic Acid (8.17 moles), and Behenic Acid (103.83 moles).

Testing of Polyamide Compositions

Drilling fluids containing the polyamide compositions were prepared for evaluation based on Formulation 1 that contained a synthetic IAO as a base oil and was weighted to 14 ppg with an oil: water ratio of 85:15. The polyamide compositions were evaluated at different loading levels which were dependent upon the efficiency of each polyamide composition in combination with 6 ppb of a dialkyl quat-bentone organoclay (“organoclay”).

TABLE 1
Drilling Fluid Formulation 1 (14 lbs/gal, 85:15 oil:water)
Formulation 1

| Raw Materials | Charge (g) | |
|---|---|---|
| Base Oil: IAO | 172.1 | |
| Emulsifier | 5 | MultiMixer Mix 2 min |
| 25% CaCl2 Brine | 48 | MultiMixer Mix 2 min |
| Lime | 10 | MultiMixer Mix 3 min |
| Organophillic Clay | 6 | MultiMixer Mix 4 min |
| Tested Additive | (See Tables) | MultiMixer Mix 4 min |
| Weighting Agent: Barite | 337.2 | MultiMixer Mix 30 min |

The drilling fluids were dynamically aged using a roller oven for 16 hours at 150° F., and then statically aged for 16 hours at 40° F. After the drilling fluids were water cooled for one hour, the fluids were mixed on a Hamilton Beach MultiMixer for 10 minutes. Viscosity measurements of the drilling fluids were measured using the Fann OFI-900 at 120° F. after each thermal cycle using test procedures API RP 13B, using standard malt cups and a 5 spindle Hamilton Beach multimixer, except for 40° F. static aging, where the viscosity measurements were made at 40° F. The observed Fann readings and at 120° F. and at 40° F. and calculated ECD's at each temperature are given in the following tables.

TABLE 1A
Description of Tested Drilling Fluid Additives (Set # 1):

| | | Load Level |
|---|---|---|
| | | (PPB) (B.38/ |
| Additive | Sample Description | Additive) |
| [BENTONE ® 38] | [Neat-BENTONE ® 38] | [9.5/0] |
| [Standard] | [IM-1/DPM solvent] [50%/50%] | [6/1.0] |
| [3196-21] | [15 wt % Oleic Acid reacted with | [6/1.2] |
| | IM-1]-[50% DPM Solvent] | |
| [3196-23] | [IM-1 made with 15 wt % Oleic | [6/1.2] |
| | acid]-[50% DPM Solvent] | |
| [3168-38] | [25 wt % Oleic Acid reacted with to | [6/0.65] |
| | IM-1]-[100% active] | |
| [3196-28] | [IM-1 made with 25 wt % Oleic | [6/0.65] |
| | acid]-[100% active] | |
| [3168-39] | [50 wt % Oleic Acid reacted with | 1[6/0.75] |
| | IM-1]-[100% active] | |
| [3196-22] | [IM-1 made with 50 wt % Oleic | [6/1.5] |
| | acid]-[50% DPM Solvent] | |
| [3196-25] | [100 wt % Oleic Acid reacted with | [6/2.0] |
| | IM-1]-[50% DPM Solvent] | |
| [3196-27] | [IM-1 made with 100 wt % Oleic | [6/2.0] |
| | acid]-[50% DPM Solvent] | |

Polyamide compositions 3196-21, 3196-38, 3196-39, and 3196-25 were made by reacting the reaction product of diethylene triamine and (C16/C18)-dicarboxylic acid (“IM-1”) with oleic acid respectively in the amount of 15%, 25%, 50% and 100% by weight of IM-1. Polyamide compositions 3168-23, 3168-28, 3168-22 and 3168-27 were made from diethylenetriamine, C16-C18 dimer acid and oleic acid in amount respectively 15%, 25%, 50% and 100% by weight of the reaction product of diethylenetriamine with C16 C18 Dimer Acid/Oleic acid. Polyamide compositions 3168-38 and 3168-39 were tested using Formulation 1 as discussed above. Polyamide compositions 3196-21, 3168-23, 3168-22, 3196-25 and 3196-27 were first treated with 50% DPM solvent and then were tested using Formulation 1 as discussed above. The observed rheological profiles for the tested compositions are shown below in Table 1B.

TABLE 1B

| | Load | HR at | HR at | HR at | | | | | | | |
|---|---|---|---|---|---|---|---|---|---|---|---|
| | Level | 150° F. | 150° F. | 150° F. | | | | | | | ECD |
| | (PPB) | 6 RPM | 10 Sec | 10 Min | 600 RPM | 10 Sec | 10 Min | ECD | ECD | ECD % | ppg |
| | (B.38/ | at | Gel at | Gel at | at | Gel | Gel | at | at | Change | Change |
| Additive | Additive) | 120° F. | 120° F. | 120° F. | 40° F. | at 40° F. | at 40° F. | 40° F. | 120° F. | 40° F.-120° F. | 40° F.-120° F. |
| [BENTONE ® 38] | [9.5/0] | 14 | 16 | 22 | 244 | 105 | 127 | 15.78 | 14.41 | 9.51 | 1.37 |
| [Standard] | [6/1.0] | 13 | 18 | 36 | 163 | 31 | 48 | 14.83 | 14.4 | 2.99 | 0.43 |
| [3196-21] | [6/1.2] | 12 | 16 | 25 | 146 | 18 | 31 | 14.66 | 14.4 | 1.81 | 0.26 |
| [3196-23] | [6/1.2] | 16 | 18 | 30 | 177 | 22 | 36 | 14.73 | 14.44 | 2.01 | 0.29 |
| [3168-38] | [6/0.65] | 15 | 19 | 34 | 170 | 33 | 46 | 14.90 | 14.39 | 3.54 | 0.51 |
| [3196-28] | [6/0.65] | 14 | 18 | 31 | 166 | 23 | 40 | 14.72 | 14.43 | 2.01 | 0.29 |
| [3168-39] | [6/0.75] | 14 | 17 | 32 | 166 | 31 | 46 | 14.90 | 14.39 | 3.54 | 0.51 |
| [3196-22] | [6/1.5] | 18 | 21 | 32 | 177 | 19 | 34 | 14.73 | 14.49 | 1.66 | 0.24 |
| [3196-25] | [6/2.0] | 14 | 18 | 30 | 162 | 19 | 33 | 14.65 | 14.39 | 1.81 | 0.26 |
| [3196-27] | [6/2.0] | 15 | 20 | 31 | 157 | 15 | 25 | 14.61 | 14.47 | 0.97 | 0.14 |
| [Standard] | [6/2.0] | 16 | 20 | 34 | 167 | 21 | 36 | 14.67 | 14.5 | 1.17 | 0.17 |
| [3196-21] | [6/2.4] | 17 | 21 | 35 | 176 | 22 | 35 | 14.81 | 14.49 | 2.21 | 0.32 |
| [3196-23] | [6/2.4] | 24 | 29 | 42 | 200 | 20 | 40 | 14.86 | 14.73 | 0.88 | 0.13 |
| [3168-38] | [6/2.5] | 17 | 21 | 35 | 192 | 21 | 36 | 14.73 | 14.46 | 1.87 | 0.27 |
| [3196-28] | [6/2.5] | 22 | 26 | 37 | 196 | 19 | 37 | 14.80 | 14.68 | 0.82 | 0.12 |
| [3168-39] | [6/3.0] | 18 | 22 | 40 | 193 | 21 | 39 | 14.90 | 14.51 | 2.69 | 0.39 |
| [3196-22] | [6/1.5] | 15 | 21 | 35 | 176 | 20 | 32 | 14.70 | 14.42 | 1.94 | 0.28 |
| [3196-25] | [6/4.0] | 20 | 26 | 42 | 210 | 25 | 42 | 14.85 | 14.53 | 2.20 | 0.32 |
| [3196-27] | [6/4.0] | 22 | 26 | 37 | 178 | 17 | 30 | 14.72 | 14.58 | 0.96 | 0.14 |

As shown by the summary of the rheological properties for the various polyamide compositions in Table 1B, the change in ECD from 40° F. to 120° F. ranged from 0.82% to 2.99% (or 0.12 ppg to 0.43 ppg). In contrast the change in ECD from 40° F. to 120° F. for BENTONE®38 was 9.51% (or 1.37 ppg).

### Example 5

TABLE 2A
Description of Drilling Fluid Additives (Set # 2):

| | | Load Level |
|---|---|---|
| | | (PPB) |
| Additive | Sample Description | (B.38/Additive) |
| [BENTONE ® 38] | [Neat-BENTONE ® 38] | [9.5/0] |
| [Standard] | [IM-1/DPM] [50%/50%] | [6/1.0] |
| [3196-47] | [C₁₆-C₁₈ Dimer Acid (100)/ | [6/1.5] |
| | Oleic Acid (8.17)/Decanoic | |
| | Acid (205.29)/DETA(139.94)] | |
| [3196-48] | [C₁₆-C₁₈ Dimer Acid (100)/ | [6/1.5] |
| | Oleic Acid (8.17)/Butyric | |
| | Acid (401.35)/DETA(139.94)] | |
| [3196-54] | [C₁₆-C₁₈ Dimer Acid (100)/ | [6/1.5] |
| | Oleic Acid (8.17)/Behenic | |
| | Acid (103.83)/DETA(139.94)] | |
| [3196-49] | [(50% IM-1/50% DPM)/Decanoic | [6/1.5] |
| | Acid/DPM] [300/75/75] by weight | |
| [3196-50] | [(50% IM-1/50% DPM)/Butyric | [6/1.5] |
| | Acid/DPM] [300/ | |
| | 75/75] by weight | |
| [3196-55] | [(50% IM-1)/50% DPM/Behenic | [6/1.5] |
| | Acid/DPM] [300/ | |
| | 75/75] by weight | |

Polyamide composition 3196-47 was made by reacting C₁₆-C₁₈ dimer acid, oleic acid, decanoic acid, and DETA in the proportions given in the parentheses. Polyamide composition 3196-48 was made by reacting C₁₆-C₁₈ dimer acid, oleic acid, butyric acid and DETA in the proportions given in the parentheses. Polyamide composition 3196-54 was made by reacting C₁₆-C₁₈ dimer acid, oleic acid, behenic acid and DETA in the proportions given in the parentheses. These compositions were tested using Formulation 1 as discussed above. The observed rheological profiles are shown below in Table 2B.

TABLE 2B

| | Load | | HR at | HR at | | | | | | | |
|---|---|---|---|---|---|---|---|---|---|---|---|
| | Level | HR at | 150° F. | 150° F. | | | | | | | ECD |
| | (PPB) | 150° F. | 10 Sec | 10 Min | | 10 Sec | 10 Min | | ECD | ECD % | ppg |
| | (B.38/ | 6 RPM | Gel at | Gel at | 600 RPM | Gel | Gel | ECD | at | Change | Change |
| Additive | Additive) | at 120° F. | 120° F. | 120° F. | at 40° F. | at 40° F. | at 40° F. | at 40° F. | 120° F. | 40° F.-120° F. | 40° F.-150° F. |
| [BENTONE ® | [9.5/0] | 13 | 16 | 22 | 312 | 105 | 127 | 16.87 | 14.41 | 17.1 | 2.46 |
| 38] | | | | | | | | | | | |
| [Standard] | [6/1.0] | 13 | 18 | 36 | 163 | 31 | 48 | 14.83 | 14.40 | 3.1 | 0.43 |
| [3196-47] | [6/1.5] | 17 | 21 | 32 | 192 | 16 | 30 | 14.77 | 14.48 | 2.0 | 0.29 |
| [3196-48] | [6/1.5] | 16 | 20 | 31 | 180 | 21 | 35 | 14.73 | 14.49 | 1.6 | 0.24 |
| [3196-54] | [6/1.5] | 9 | 12 | 16 | 134 | 14 | 22 | 14.51 | 14.34 | 1.1 | 0.17 |
| [3196-49] | [6/1.5] | 14 | 17 | 32 | 156 | 20 | 32 | 14.68 | 14.41 | 1.9 | 0.27 |
| [3196-50] | [6/1.5] | 10 | 12 | 16 | 140 | 18 | 30 | 14.58 | 14.31 | 1.9 | 0.27 |
| [3196-55] | [6/1.5] | 8 | 10 | 13 | 140 | 21 | 28 | 14.68 | 14.29 | 2.7 | 0.39 |
| [Standard] | [6/2.0] | 16 | 20 | 34 | 167 | 21 | 36 | 14.67 | 14.50 | 1.2 | 0.17 |
| [3196-47] | [6/3.0] | 28 | 33 | 55 | 239 | 18 | 32 | 15.05 | 14.68 | 2.5 | 0.37 |
| [3196-48] | [6/3.0] | 28 | 35 | 57 | 224 | 24 | 54 | 15.16 | 14.68 | 3.3 | 0.48 |
| [3196-54] | [6/3.0] | 16 | 19 | 27 | 178 | 15 | 26 | 14.70 | 14.51 | 1.3 | 0.19 |
| [3196-49] | [6/3.0] | 22 | 28 | 45 | 206 | 21 | 40 | 14.87 | 14.65 | 1.5 | 0.22 |
| [3196-50] | [6/3.0] | 14 | 15 | 26 | 173 | 20 | 37 | 14.68 | 14.39 | 2.0 | 0.29 |
| [3196-55] | [6/3.0] | 12 | 14 | 20 | 150 | 21 | 37 | 14.67 | 14.38 | 2.0 | 0.29 |

As shown by the summary of the rheological properties for the various polyamide compositions tested in Formula 1, the change in ECD from 40° F. to 120° F. ranged from 1.1 to 3.1% (or 0.17 to 0.48 ppg). In contrast, for BENTONE® 38, the change in ECD from 40° F. to 120° F. was 17.1% (or 2.46 ppg).

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modifications will be apparent to those skilled in the art, and may be made without departing from the spirit or scope of the disclosure.

We claim:

1. A method of providing a substantially constant rheological profile of an oil-based drilling fluid over a temperature range of about 120° F. to about 40° F. comprising adding a drilling fluid additive to the drilling fluid, wherein the drilling fluid additive consists essentially of a polyamide having (a) repeat units of (i) a poly-carboxyl unit with at least two carboxylic moieties; and (ii) a polyamine unit having an amine functionality of two or more and (b) one or more mono-carboxyl units, said mono-carboxyl units being positioned on the polyamide at a position selected from the group consisting of: an end position, a pendant position and combinations thereof.

2. The method of claim 1, wherein the poly-carboxyl unit is derived from a dimer fatty acid.

3. The method of claim 2, wherein the dimer fatty acid is selected from the group consisting of hydrogenated, partially hydrogenated and non-hydrogenated fatty dimer acids with from about 20 to about 48 carbon atoms.

4. The method of claim 2, wherein the dimer fatty acid is selected from the group consisting of a C16 dimer fatty acid, a C18 dimer fatty acid and mixtures thereof.

5. The method of claim 1, wherein the polyamine unit is derived from a polyethylene polyamine.

6. The method of claim 5, wherein the polyamine is selected from the group consisting of ethylenediamine, diethylenetriamine, triethylenetriamine and tetrayethylenepentamine.

7. The method of claim 5, wherein the polyamine is diethylenetriamine.

8. The method of claim 1, wherein the mono-carboxyl unit has a formula (R¹—C═O) wherein R¹ is a saturated or unsaturated hydrocarbon having from 3 carbon atoms to 22 carbon atoms.

9. The method of claim 1, wherein the mono-carboxyl unit is derived from a monocarboxylic acid group selected from the group consisting of: butyric acid, hexanoic acid, octanoic acid, decanoic acid, dodecanoic acid, tetradecanoic acid, hexadecanoic acid, octadecanoic acid, eicosanoic acid, docosanoic acid, oleic acid, linoleic acid, and mixtures thereof.

10. The method of claim 1, further comprising adding one or more emulsifiers to the drilling fluid.

11. The method of claim 1, further comprising adding an organoclay to the drilling fluid.

12. The method of claim 1, further comprising adding to the drilling fluid one or more of: a fluid loss reducing additive and a weight agent.

13. The method of claim 1 wherein the increase in high shear rate viscosity of the drilling fluid is less than about 75% when the drilling fluid is cooled from about 120° F. to about 40° F.

14. The method of claim 1, comprising adding less than about 2 ppb drilling fluid additive to the drilling fluid.

15. A composition consisting essentially of a polyamide having (a) repeat units of (i) a poly-carboxyl unit with at least two carboxylic moieties; and (ii) a polyamine unit having an amine functionality of two or more and (b) one or more mono-carboxyl units, said mono-carboxyl units being positioned on the polyamide at a position selected from the group consisting of: an end position, a pendant position and combinations thereof.

16. The composition of claim 15, wherein the poly-carboxyl unit is derived from a dimer fatty acid.

17. The composition of claim 16, wherein the dimer fatty acid is selected from the group consisting of hydrogenated, partially hydrogenated and non-hydrogenated fatty dimer acids with from about 20 to about 48 carbon atoms.

18. The composition of claim 17, wherein the dimer fatty acid is selected from the group consisting of a C16 dimer fatty acid, a C18 dimer fatty acid and mixtures thereof.

19. The composition of claim 16, wherein the polyamine unit is derived from polyethylene polyamine.

20. The composition of claim 19 wherein the polyamine is selected from the group consisting of ethylenediamine, diethylenetriamine, triethylenetriamine and tetrayethylenepentamine.

21. The composition of claim 20, wherein the polyamine comprises diethylenetriamine.

22. The composition of claim 16, wherein the mono-carboxyl unit has a formula (R¹—C═O) wherein R¹ is a saturated or unsaturated hydrocarbon having from 3 carbon atoms to 22 carbon atoms.

23. The composition of claim 22, wherein the mono-carboxyl unit is derived from a monocarboxylic acid group selected from the group consisting of: butyric acid, hexanoic acid, octanoic acid, decanoic acid, dodecanoic acid, tetradecanoic acid, hexadecanoic acid, octadecanoic acid, eicosanoic acid, docosanoic acid, oleic acid, linoleic acid, and mixtures thereof.

24. An oil-based drilling fluid comprising the composition of claim 16.

25. The oil-based drilling fluid of claim 24, wherein the increase in high shear rate viscosity of the drilling fluid is less than about 75% when the said drilling fluid is cooled from about 120° F. to about 40° F.

26. An oil-based drilling fluid comprising less than about 2 ppb of the composition of claim 20.
